(19) United States
(12) Patent Application Publication
(10) Pub. No.: US 2006/0186816 A1
(43) Pub. Date: Aug. 24, 2006

(54) Electric lamp

(75) Inventor: Akira Kurosawa, Monou-gun (JP)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/566,198

(22) PCT Filed: Jul. 26, 2004
(86) PCT No.: PCT/IB04/51288

§ 371 Date: Jan. 25, 2006

(30) Foreign Application Priority Data
Jul. 28, 2003 (WO) PCT/IB03/03335

(51) Int. Cl. H01J 61/30; H01J 61/35

(52) U.S. Cl. 313/635; 313/634

(57) ABSTRACT

An electric lamp (1) according to the present invention is so constructed that it comprises a bulb (2) comprising a first curved face (10), the first curved face having a substantially ellipsoidal shape in cross section with a first focal point (F1) and a second focal point (F2), and being convex outwardly, and a filament (6) comprising a coil part (16) formed by winding a wire and generating a light by being energized, the filament being so arranged that the coil part (16) is positioned in an inner space (5) of the bulb (2), wherein a reflective coating is formed on the whole of outer surface or the whole of inner surface of the first curved face (10), and wherein the first curved face (10) is so adapted that the first focal point (F1) is positioned at the coil part (16), and the second focal point (F2) is positioned at a light transmission medium (20) to which an emerged light generated at the coil part (16) and reflected on the first curved face (10) is provided.

### TECHNICAL FIELD

The present invention relates to an incandescent type electric lamp including a halogen lamp, etc., and more particularly, to an electric lamp used as a light source of an optical fiber lighting system.

### BACKGROUND ART

Conventionally, an optical fiber lighting system is widely used for lighting to illuminate areas near the hands of workers who perform elaborate work, for example, at a factory, and decorative lighting of a show case or show window on one hand, and for irradiation necessary for an endoscope, scanner, photoenlarger, photopolymerizer, etc., on the other.

FIG. 7 schematically shows an example of an optical fiber lighting system wherein a conventional halogen lamp is used as a light source, of which A shows the spatial relationship between the halogen lamp and an optical fiber, and B shows a light distribution of an emerged light emerged from the optical fiber. In FIG. 7, reference numeral 100 denotes a halogen lamp and 200 denotes an optical fiber. The halogen lamp 100 includes a bulb 101 made of quartz glass and a reflector 102 made of glass. The bulb 101 is provided with a seal 103 and a halogen gas is filled in the bulb 101. Furthermore, a so-called longitudinal filament 104 (e.g., C-8 type) is arranged in the bulb 101. The reflector 102 is provided with an ellipsoidal reflective portion 105, on the inner surface of which a reflective coating is formed, and a neck-shaped portion 106. The seal 103 of the bulb 101 is inserted in the neck-shaped portion 106 of the reflector 102 and fixed using an adhesive such as cement. In this case, the bulb 101 and reflector 102 are concentrically positioned so that the coil axis of the filament 104 coincides with the optical axis of the reflective portion 102 (see single-dot dashed line in the figure).

For the optical fiber 200, a quartz-based optical fiber, multi-component optical fiber or plastic optical fiber, etc., may be used. In the figure, only one optical fiber is shown, but several to several tens of thousands of fibers are normally used as tied in a bundle. Furthermore, the optical fiber 200 has a numerical aperture NA which indicates an angle at which it can receive a light on its end face. According to the numerical aperture NA of the optical fiber 200 used and a curvature of the reflective portion 105 of the reflector 102 of the halogen lamp 100, the halogen lamp 100 and optical fiber 200 are positioned at an appropriate distance X from each other. In this case, the halogen lamp 100 and optical fiber 200 are concentrically positioned so that the axis of the (bundled) optical fiber 200 coincides with the optical axis of the reflective portion 105 of the reflector 102(see single-dot dashed line in the figure).

In the optical fiber lighting system in FIG. 7, an emerged light emerged from the optical fiber 200 has a light distribution as shown in FIG. 7B. This light distribution is also shown concentrically with the halogen lamp 100 and optical fiber 200.

As is evident from the light distribution in FIG. 7B, luminous intensity near the center of light emerged from the optical fiber 200 drops compared to luminous intensity on the periphery in the conventional optical fiber lighting system. This is attributable to the fact that the reflector 102 is provided with the neck-shaped portion 106. That is, no reflective coating can be formed in this area of the reflector 102, and therefore a dark spot which does not allow light to be reflected is formed. As a result, most of the reflected light from the reflector 102 enters the optical fiber 200 at a certain angle of incidence. When the light enters the optical fiber at a certain angle, the light is transmitted inside the optical fiber while repeating total reflection. Here, since angle of incidence=angle of reflection, the light emerged from the other end of the optical fiber consequently has a doughnut shape. Moreover, a quantity of light generated by the tip portion of the filament 104 facing the optical fiber 200 is not so great. Therefore, the quantity of light which directly enters the optical fiber 200 from the filament 104 in parallel is not so great. Thus, the conventional optical fiber system resultantly has a light distribution wherein the luminous intensity is depressed in the central area as shown in FIG. 7B. Such a light distribution is not appropriate for optical fiber illumination except for special applications. With consideration given to this point, there is an attempt to enter a parallel light from the halogen lamp to the optical fiber by positioning the halogen lamp and optical fiber, while forming an angle between the optical axis of the halogen lamp 100 and the axis of the optical fiber 200. In this case, however, the quantity of light not incident upon the optical fiber increases, resulting in poor efficiency. Thus, the conventional halogen lamp has a problem that it is not appropriate as a light source of an optical fiber lighting system.

Furthermore, when the halogen lamp 100 shown in the figure is used, a mold for molding the glass reflector 102 is very expensive, and it is therefore difficult to provide many types of ellipsoidal reflective portions 105 of the reflector 102 with different curvatures and providing them involves an enormous cost. It is an actual situation that only a few types of reflector can be provided and they are adapted by adapting the size, form, etc., of the bulb according to the application or displacing the bulb inside the reflector according to the application. However, with such adaptations, it is difficult to obtain a desired light distribution characteristic and may be even impossible to do so.

Furthermore, when the halogen lamp 100 in the figure is used, the reflector 102 as a part independent of the bulb is required, which results in a problem that it is difficult to reduce the size of the optical fiber lighting system.

Note that an optical fiber lighting system using an incandescent electric lamp as a light source is known in German Utility Model No.DE-7904647 U. This optical fiber lighting system is provided with a reflective layer on the bulb of the incandescent electric lamp. This optical fiber lighting system also has a characteristic that luminous intensity near the central area in a light distribution of the light emerged from the optical fiber drops compared to the luminous intensity on the periphery.

### DISCLOSURE

It is an object of the present invention to provide an incandescent type electric lamp, a halogen lamp in particular, which is suitable as a light source for an optical fiber lighting system, which can be manufactured at a low cost and which is small.

In order to attain this object, the electric lamp according to the present invention is characterized by comprising a bulb comprising a first curved face, the first curved face having a substantially ellipsoidal shape in cross section with a first focal point and a second focal point, and being convex outwardly, and, a filament comprising a coil part formed by winding a wire and generating a light by being energized, the filament being so arranged that the coil part is positioned in an inner space of the bulb, wherein a reflective coating is formed on the whole of outer surface or the whole of inner surface of the first curved face, and the first curved face is so adapted that the first focal point is positioned at the coil part, and the second focal point is positioned at a light transmission medium to which an emerged light generated at the coil part and reflected on the first curved face is provided.

According to the electric lamp in the above-described structure, the first curved face having a substantially ellipsoidal shape in cross section is made in the bulb itself of the electric lamp and the reflective coating is formed on the whole of outer surface or the whole of inner surface of the first curved face, and therefore it is possible to manufacture the electric lamp at a low cost and reduce the size of the electric lamp considerably. Furthermore, in the light transmission medium lighting system using the electric lamp in the above-described structure as a light source, emerged light of the light transmission medium such as an optical fiber can have a light distribution characteristic having a peak in the vicinity of the center. A light having such a light distribution characteristic is quite suitable for an application of optical fiber lighting.

Preferably, in the above-described electric lamp, a second face, facing the first curved face, includes a substantially spherical shape and the bulb further comprises a circumferential face for interconnecting a circumferential end portion of the first curved face and a circumferential end portion of the second face.

According to the electric lamp in the above-described structure, it is advantageous because the thickness of the bulb of the electric lamp is substantially fixed in the portion of the inner space of the bulb. Equalizing the thickness of the glass is advantageous in preventing bursting of the bulb.

Preferably, in the above-described electric lamp, the second face includes a flat portion and preferably, the flat portion has a circular shape, and has at least a size of passing almost all of emerged light generated at the coil part at the first focal point and reflected on the first curved face.

According to the electric lamp in the above-described structure, it is advantageous in that it is possible to easily position the electric lamp and light transmission medium by letting the flat portion contact a flat reference surface provided in the light transmission medium lighting system. It is also advantageous in that that the emerged light that passes through the flat portion refracts only at a small degree at the flat portion. It is further advantageous in that it is possible to accurately visually confirm the position of the filament through the flat portion.

Preferably, in the above-described electric lamp, the second face comprises a protrusion portion, which protrudes toward the light transmission medium.

According to the electric lamp in the above-described structure, it is advantageous in that the electric lamp and light transmission medium can be positioned extremely easily by inserting the protrusion portion in the hole of the reference surface provided in the light transmission medium lighting system.

Preferably, in the above-described electric lamp, the second face has a coating for reflecting, transmitting or absorbing a light of a particular wavelength.

According to the electric lamp in the above-described structure, it is advantageous in the aspects of cost and miniaturization of the light transmission medium lighting system, because there is no need to separately provide a filter having characteristics such as infrared cutting.

Furthermore, the electric lamp according to the present invention is characterized by comprising a bulb comprising a first curved face, the first curved face having a substantially ellipsoidal shape in cross section with a first focal point and a second focal point, and being convex outwardly, and a second curved face, facing the first curved face, the second curved face having a substantially ellipsoidal shape in cross section with a first focal point and a second focal point, and being convex outwardly, and a filament comprising a coil part formed by winding a wire and generating a light by being energized, the filament being so arranged that the coil part is positioned in an inner space of the bulb, wherein the respective reflective coatings are formed on the first curved face and the second curved face, wherein the reflective coating comprises an opening for passing an emerged light generated at the coil part and reflected on the first curved face or the second curved face, the first curved face is so adapted that the first focal point is positioned at the coil part, and the second focal point is positioned at a light transmission medium to which an emerged light generated at the coil part and reflected on the first curved face is provided through the opening, and the second curved face is so adapted that the first focal point is positioned at the coil part, and the second focal point is positioned at a light transmission medium to which an emerged light generated at the coil part and reflected on the second curved face is provided through the opening. Preferably, the first and second curved faces have the same curvature. Furthermore, preferably, at least one of the openings has a circular shape, and has at least a size of passing almost all of emerged light generated at the coil part at the first focal point of the first curved face or the second curved face and reflected on the first curved face or the second curved face.

According to the electric lamp in the above-described structure, the first and second curved faces having a substantially ellipsoidal shape in cross section are made in the bulb itself of the electric lamp and a reflective coating is formed on the first and second curved faces, and therefore it is possible to manufacture the electric lamp at a low cost and reduce the size of the electric lamp considerably. Furthermore, the light transmission medium lighting system using the electric lamp in the above-described structure as a light source allows light to enter light transmission media such as two optical fibers by this one electric lamp and allows emerged lights from these light transmission media to have a light distribution characteristic having a peak in the vicinity of the center. Such a light distribution characteristic is quite suitable for applications of optical fiber lighting.

Preferably, in the above-described electric lamp, at least one of the openings includes a flat portion.

According to the electric lamp in the above-described structure, it is advantageous in that it is possible to easily position the electric lamp and light transmission medium by letting the flat portion contact the flat reference surface provided in the light transmission medium lighting system. It is also advantageous that the emerged light which passes through the flat portion refracts only at a small degree at that flat portion. It is further advantageous in that it is possible to visually accurately confirm the position of the filament through the flat portion.

Preferably, in the above-described electric lamp, at least one of the openings comprises a protrusion portion, which protrudes toward the light transmission medium.

According to the electric lamp in the above-described structure, it is advantageous in that it is possible to position the electric lamp and light transmission medium extremely easily by inserting the protrusion portion in the hole of the reference surface provided in the light transmission medium lighting system.

Preferably, in the above-described electric lamp, an end face of the protrusion portion has a lens effect.

According to the electric lamp in the above-described structure, it is advantageous in that it is possible to condense, diffuse or collimate a light in a desired direction.

Preferably, in the above-described electric lamp, a reflective coating is formed on a side face of the protrusion portion.

According to the electric lamp in the above-described structure, it is advantageous in that the light does not escape from the side face of the protrusion portion.

Preferably, in the above-described electric lamp, the coil part has a square shape or a circular shape as viewed from the light transmission medium side.

According to the above-described electric lamp in the above-described structure, it is advantageous in that it is possible to prevent the light generated at the coil part of the filament and reflected on the first or second curved face from being intercepted by the filament.

Preferably, in the above-described electric lamp, the bulb comprises a circumferential face for interconnecting a circumferential end portion of the first curved face and a circumferential end portion of the second curved face.

According to the electric lamp in the above-described structure, it is advantageous in that the thickness of the bulb of the electric lamp can be substantially fixed in the portion of the inner space of the bulb. Equalizing the thickness of the glass is also advantageous in preventing bursting of the bulb.

Preferably, in the above-described electric lamp, the material of the reflective coating is Ta₂O₅/SiO₂.Ta₂0₅/SiO₂ is excellent in the aspects of heat resistance and exfoliation resistance.

Preferably, in the above-described electric lamp, the first curved face and/or the second curved face consist of plural portions with different curvatures.

According to the electric lamp in the above-described structure, it is advantageous in that it is possible to condense light on different second focal points on a light transmission medium such as an optical fiber.

Preferably, in the above-described electric lamp, halogen is filled in the inner space of the bulb.

Furthermore, according to the present invention, a light transmission medium lighting system, or an optical fiber lighting system in particular, is characterized by comprising an electric lamp and a light transmission medium, the electric lamp comprising a bulb comprising a first curved face, the first curved face having a substantially ellipsoidal shape in cross section with a first focal point and a second focal point, and being convex outwardly, and a second face, facing the first curved face, and a filament comprising a coil part formed by winding a wire and generating a light by being energized, the filament being so arranged that the coil part is positioned in an inner space of the bulb, and the light transmission medium being arranged in the vicinity of the second face, to which an emerged light generated at the coil part and reflected on the first curved face is provided, wherein a reflective coating is formed on the whole of outer surface or the whole of inner surface of the first curved face, and the first curved face is so adapted that the first focal point is positioned at the coil part, and the second focal point is positioned at the light transmission medium.

Furthermore, according to the present invention, a light transmission medium lighting system, or an optical fiber lighting system in particular, is characterized by comprising an electric lamp and two light transmission media, the electric lamp comprising a bulb comprising a first curved face, the first curved face having a substantially ellipsoidal shape in cross section with a first focal point and a second focal point, and being convex outwardly, and a second curved face, facing the first curved face, the second curved face having a substantially ellipsoidal shape in cross section with a first focal point and a second focal point, and being convex outwardly, and a filament comprising a coil part formed by winding a wire and generating a light by being energized, the filament being so arranged that the coil part is positioned in an inner space of the bulb, and the two light transmission media being arranged in the vicinity of the first curved face and the second curved face, respectively, to which an emerged light generated at the coil part and reflected on the first curved face or the second curved face is provided, wherein the respective reflective coatings are formed on the first curved face and the second curved face, the reflective coating comprises an opening for passing an emerged light generated at the coil part and reflected on the first curved face or the second curved face, the first curved face is so adapted that the first focal point is positioned at the coil part, and the second focal point is positioned at one light transmission medium to which an emerged light reflected on the first curved face is provided through the opening, and the second curved face is so adapted that the first focal point is positioned at the coil part, and the second focal point is positioned at the other light transmission medium to which an emerged light reflected on the second curved face is provided through the opening.

### DESCRIPTION OF DRAWINGS

FIG. 1 is a schematic view of a first embodiment of an electric lamp according to the present invention, of which A shows a front view, B a left side view and C a right side view;

FIG. 2 schematically shows a manufacturing step of the lamp according to the present invention as shown in FIG. 1;

FIG. 3 schematically shows an optical fiber lighting system wherein the lamp according to the present invention as shown in FIG. 1 is used as a light source, of which A shows the spatial relationship between the light source and an optical fiber, and B schematically shows a light distribution of an emerged light emerged from the optical fiber;

FIG. 4 is a schematic view of a second embodiment of an electric lamp according to the present invention, of which A shows a front view, B a left side view and C a right side view;

FIG. 5 is a schematic view of a third embodiment of an electric lamp according to the present invention, of which A shows a front view, and B a left side view;

FIG. 6 is a schematic view of a fourth embodiment of an electric lamp according to the present invention, of which A shows a front view, and B a left side view; and

FIG. 7 schematically shows an optical fiber lighting system wherein a conventional halogen lamp is used as a light source, of which A shows the spatial relationship between the light source and an optical fiber, and B shows a light distribution of an emerged light emerged from the optical fiber.

### BEST MODE

With reference now to the attached drawings, embodiments of the present invention will be explained in detail below.

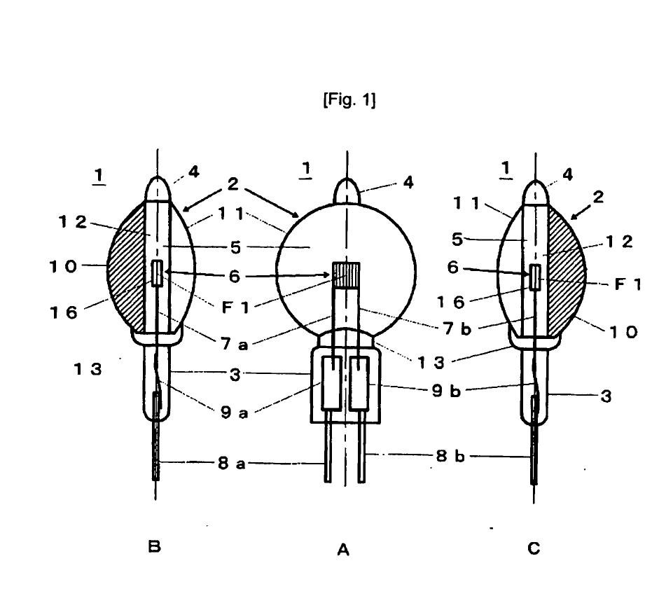

FIG. 1 is a schematic view of a first embodiment of an electric lamp according to the present invention, of which A shows a front view, B a left side view and C a right side view. An electric lamp 1 in this embodiment is a halogen lamp. This halogen lamp 1 includes a bulb 2 made of, for example, quartz glass. The lower part of this bulb is formed with a pinch seal 3, the tip thereof is formed with an evacuation seal 4 and a halogen gas is filled in an inner space 5. Furthermore, a filament 6 made of, for example, tungsten wire is provided in the inner space 5 of the bulb 3. The filament 6 comprises a coil part 16 formed by winding a wire and generating a light by being energized. In the pinch seal 3, a pair of inner leads (a pair of linear end portions also serve as these inner leads in this embodiment) 7a, 7b and a pair of outer leads 8a, 8b are implanted and the inner leads 7a, 7b and outer leads 8a, 8b are electrically connected through Mo foils 9a and 9b, respectively. In this embodiment, the coil part 16 of the filament 6, the inner leads 7a, 7b, the outer leads 8a, 8b and the Mo foils 9a, 9b (that is, filament structure which will be described later) extend in substantially parallel to the axis of the bulb 2 (single-dot dashed line in FIG. 1) which passes through the filament 6. In this embodiment, the pinch seal 3 is provided concentrically with the axis of the bulb 2. However, this is not an essential structure and as required, it is also possible to provide the pinch seal 3 eccentrically with respect to the axis of the bulb 2 and adapt the filament structure thereto.

In this embodiment, the bulb 2 has a substantially ellipsoidal shape in cross section with a first focal point F1 and a second focal point F2 and has an outwardly convex first curved face 10. A reflective coating (diagonally shaded area in FIG. 1) is formed on the whole of outer surface of the first curved face 10. In this embodiment, the optical axis of the first curved face 10 is substantially orthogonal to the axis of the bulb 2 and the plane formed at a circumferential end portion of the first curved face is substantially parallel to the axis of the bulb 2. The first focal point F1 of the first curved face 10 is positioned at the coil part 16 of the filament 6. The second focal point F2 of the first curved face 10 is positioned at an optical fiber 20 to which an emerged light generated at the coil part 16 of the filament 6 and reflected on the first curved face 10 is provided (see FIG. 3).

In this embodiment, the bulb 2 has a substantially spherical second face 11, facing the first curved face 10. Furthermore, the bulb 2 comprises a circumferential face 12 for interconnecting a circumferential end portion of the first curved face 10 and a circumferential end portion of the second face 11. The circumferential face 12 and seal 3 are interconnected through a transition portion 13. Providing the spherical second face 11 and circumferential face 12 is advantageous for substantially fixing the thickness of the bulb 2 of the electric lamp 1 in the portion of the inner space 5. The reason for this will be explained with reference to a manufacturing step of the lamp of this embodiment.

Manufacturing of the electric lamp of this embodiment is basically the same as that of the conventional halogen lamp. Furthermore, the method of molding the bulb is also the same as the conventional manufacturing method. The first curved face 10 having a substantially ellipsoidal shape in cross section, the substantially spherical second face 11 and the circumferential face 12 of the bulb 2 are molded by heating a predetermined portion of a glass tube having a predetermined tube diameter first, then surrounding the heated portion with a mold, blowing air into the tube and inflating the heated portion. In that case, a similar wind pressure is applied to portions equidistant from the axis of the glass tube, and therefore the thickness of glass after molding becomes uniform. In this embodiment, in the case of the above-described inflation, the distances from a point on the axis of the glass tube to the second face 11 and circumferential face 12 and part of the first curved face 10 are generally equal, and therefore the thickness of the glass after molding becomes equal. Equalizing the thickness of the glass is advantageous in preventing bursting of the bulb.

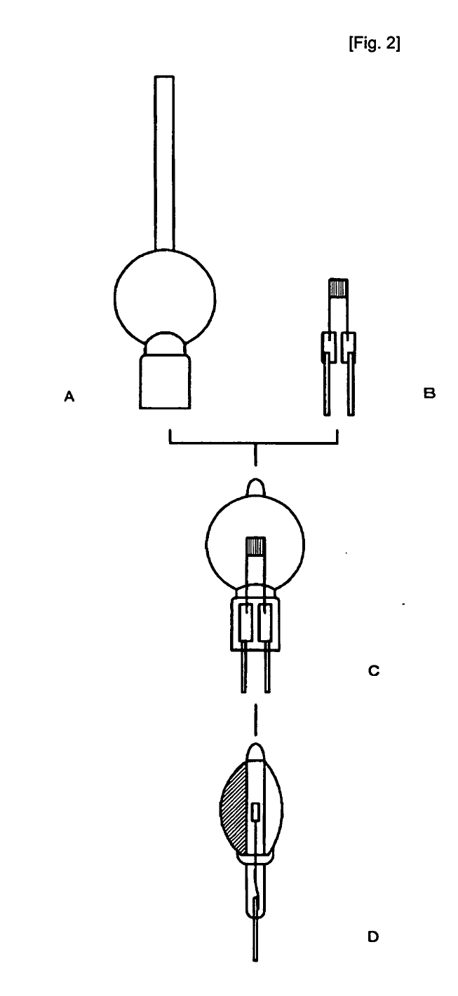

Furthermore, when the above-described bulb 2 is molded, the portion corresponding to the seal 3 and transition portion are also molded. The glass tube thus molded is shown in FIG. 2A.

On the other hand, the filament 6 provided with the coil part 16, inner leads 7a, 7b, outer leads 8a, 8b and Mo foils 9a, 9b are electrically welded, whereby a filament structure shown in FIG. 2B is formed. This filament structure is inserted into the glass tube molded as shown in FIG. 2A from below, and fixed to a predetermined position, whereafter the portion corresponding to the seal 3 is heated and pinch-sealed. Then, a halogen gas is introduced from the tip of the glass tube. Finally, the tip of the glass tube is heated and then sealed (see FIG. 2C).

Then, a reflective coating is formed on the whole of outer surface of the first curved face 10 by means of vapor deposition such as CVD and the electric lamp is completed (see FIG. 2D). The reflective coating may also be formed on the whole of outer surface of the curved face 10 before the filament structure shown in FIG. 2B is inserted into the glass tube molded as shown in FIG. 2A. Furthermore, the reflective coating may also be formed on the whole of inner surface of the first curved face 10 instead of its outer surface.

Note that it is preferable to narrow the above-described transition portion 13 (especially see FIG. 1A) as much as possible so as to make the area of reflection of the first curved face 10 as large as possible.

Furthermore, according to the above-described manufacturing method, the first curved face 10, second face 11 and circumferential face 12, portion corresponding to the seal 3 and transition portion are molded from one glass tube, but these components may also be molded from different glass tubes and then united.

In the above-described explanation, the first curved face 10, second face 11 and circumferential face 12 are treated as different components, but the present invention may also be adapted so that a circumferential face is included in the first and/or second curved face and is formed when the first curved face and second face are contacted so as to form an inner space.

In contrast to the conventional halogen lamp, according to the electric lamp of this embodiment, the reflective coating is directly formed on the outer surface of the bulb, and therefore the material of the reflective coating is required to have heat resistance.

Furthermore, since it is expected that the electric lamp is frequently touched by human hands during the manufacturing work, a high degree of peeling resistance is also required. With all these points taken into consideration, in this embodiment, Ta₂O₅/SiO₂ which is excellent in the aspects of heat resistance and strength is used as the material for the reflective coating. However, it is also possible to use materials such as aluminum, gold, ZnS/MgF₂, ZnS/SiO₂, TiO₂/SiO₂as required.

In this embodiment, the filament 6 provided with the coil part 16 is of a so-called transverse CF-6 type, has a square shape as viewed from the optical fiber 20 side and is placed in the inner space 5 of the bulb 2 such that the optical axis of the first curved face 10 passes through the center of the square shape. Furthermore, the first focal point F1 of the first curved face 10 is positioned in the center of the coil part 16 of the filament 6. This is advantageous in that the emerged light generated at the coil part 16 of the filament 6 and reflected on the first curved face 10 is prevented from being intercepted by the filament 6. However, in this respect, it is preferable for this embodiment that the filament 6 is of a CF-6 type, has a circular shape as viewed from the optical fiber 20 side and placed in the inner space 5 of the bulb 2 such that the optical axis of the first curved face 10 passes through the center of the circular part.

However, it is also possible to adopt a rectangular shape as viewed from the optical fiber 20 side and also use a filament of a C-6 type, CF-8 type, etc., as required.

FIG. 3 schematically shows an optical fiber lighting system wherein the lamp as shown in FIG. 1 is used as a light source, of which A shows the spatial relationship between the electric lamp and an optical fiber, and B schematically shows a light distribution of an emerged light emerged from the optical fiber. In this optical fiber lighting system, the electric lamp 1 and optical fiber 20 are concentrically positioned at a predetermined distance Y from each other so that the optical axis of the first curved face 10 substantially coincides with the axis of the optical fiber 20 (see single-dot dashed line in FIG. 3). Here, the curvature of the first curved face 10 is adapted to the numerical aperture NA of the optical fiber 20 and the second focal point F2 of the first curved face 10 is positioned at the optical fiber 20. Note that the optical fiber 20 itself can be the same as the conventional one and a plurality of optical fibers may be bundled. Thus, as shown in FIG. 3, an emerged light generated at the coil part 16 of the filament 6 at the first focal point F1 and reflected on the first curved face 10 is condensed on the second focal point F2 positioned at the optical fiber 20. According to this embodiment, since the reflective coating is formed on the whole of outer surface of the first curved face 10, there is no dark spot. Furthermore, since no seal 3, etc., exists on the optical axis of the first curved face 10, the emerged light is not blocked. Furthermore, on the side viewed from the optical fiber 20, a parallel light directly enters the optical fiber 20 from the square-shaped coil part 16. This coil part generates an extremely large quantity of light. As a result, a light distribution is obtained which is not doughnut-shaped but has a peak in the vicinity of the center as shown in FIG. 3B. This light distribution is also expressed concentrically with the halogen lamp 1 and optical fiber 20. Such a light distribution is quite suitable for the aforementioned application of optical fiber lighting.

Then, an experiment was conducted in the same optical fiber lighting system to compare quantities of light emerged from the optical fiber when a conventional halogen lamp provided with a separate reflector and the electric lamp according to the present invention are respectively lit at the same voltage (5 V). As a result, it has been confirmed that an increase of light quantity of approximately 32% is obtained using the electric lamp of the present invention.

Furthermore, compared to the cost for molding the conventional separate reflector, the cost for molding the bulb 2 is extremely cheep.

Moreover, the electric lamp of the present invention is very small in size because it includes no separate reflector. Furthermore, the ellipsoidal shaped portion of the bulb of the electric lamp of the present invention is small and can have an extremely short focus. Compared to the conventional electric lamp, this allows the electric lamp of the present invention to be brought closer to the optical fiber. Therefore, in the conventional optical fiber lighting system using the conventional electric lamp with a separate reflector as a light source, the space required for the conventional electric lamp is enough for the electric lamp according to the present invention. Therefore, it is possible to adapt the electric lamp according to the present invention to the conventional optical fiber lighting system by only changing the mounting structure of the electric lamp. On the other hand, when a new optical fiber lighting system is manufactured, the size of such a system can be made smaller than the conventional optical fiber lighting system.

Among conventional optical fiber lighting systems, one with a separate infrared cut filter, etc., interposed between the electric lamp and optical fiber is known. It is possible to omit such a separate filter by forming a coating having an infrared cut filter characteristic on the second face 11 of the electric lamp in FIG. 1. This is advantageous in the aspects of cost and miniaturization of the system. If desired, it is also possible to form a coating having other characteristics such as an infrared reflection filter, ultraviolet cut filter, dichroic filter, etc., on the second face 11.

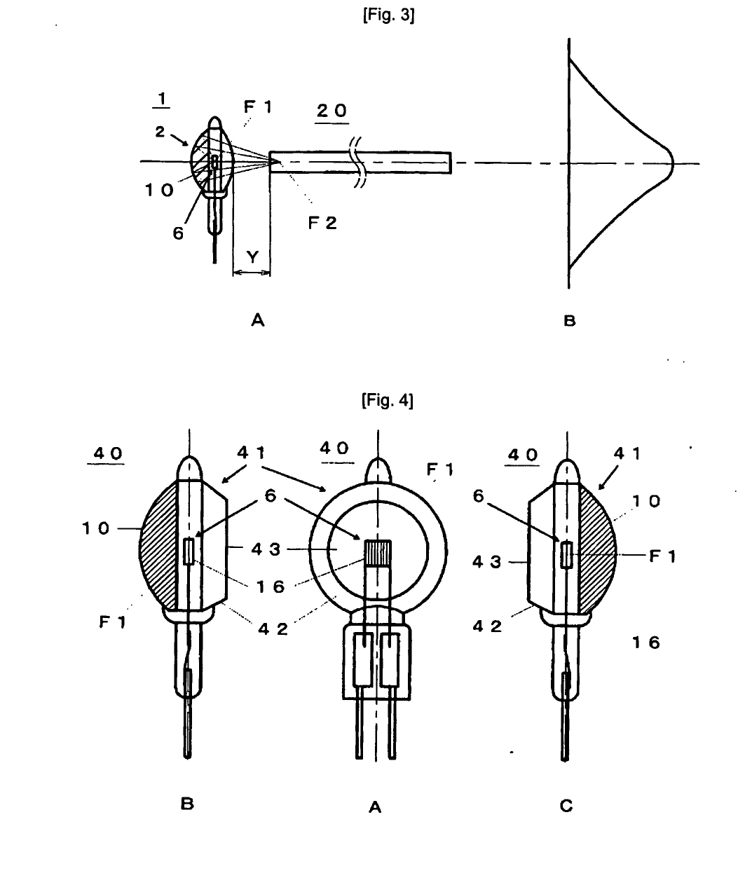

FIG. 4 is a schematic view of a second embodiment of an electric lamp according to the present invention, of which A shows a front view, B a left side view and C a right side view. An electric lamp 40 of this embodiment is different from the electric lamp 1 according to the first embodiment in FIG. 1 in that a bulb 41 has a substantially truncated cone shaped second face 42 provided with a flat portion 43 instead of the substantially spherical second face 11. The flat portion 43 has a circular shape, and has a size of passing almost all of emerged light generated at the coil part 16 of the filament 6 at the first focal point F1 and reflected on the first curved face 10. The electric lamp 40 according to this embodiment is advantageous in that it is possible to easily position the electric lamp and optical fiber by letting the flat portion 43 contact a flat reference surface provided in the optical fiber lighting system. Furthermore, it is also advantageous in that the emerged light passing through the flat portion 43 is refracted only at a small degree in the flat portion 43. It is further advantageous in that the position of the filament 6 can be visually accurately confirmed through the flat portion 43.

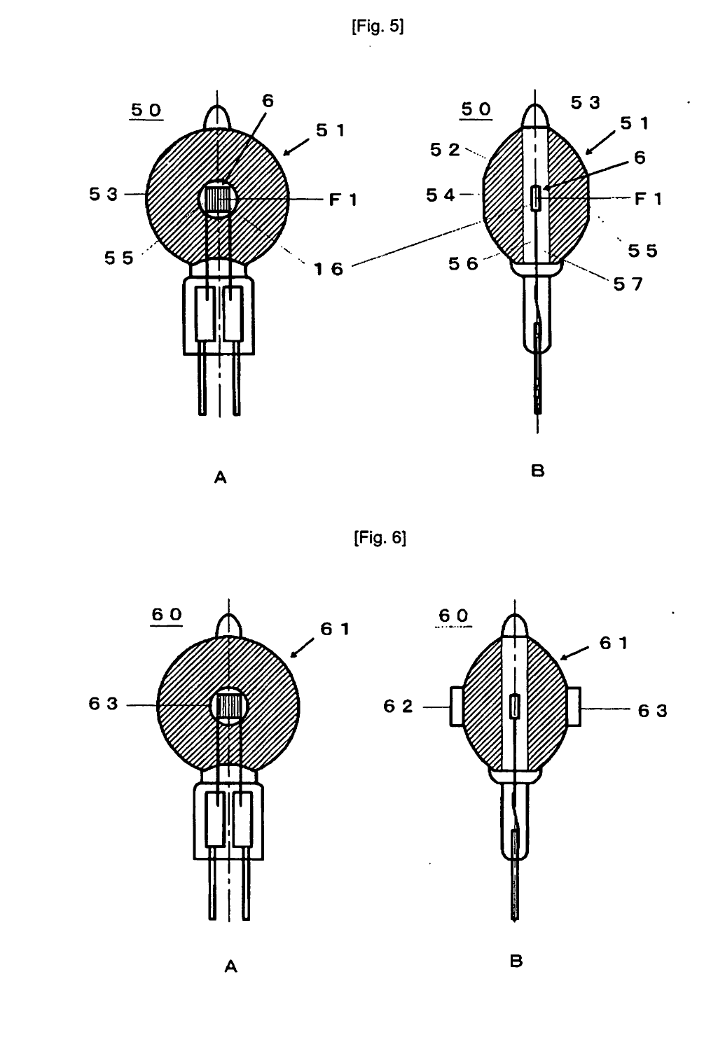

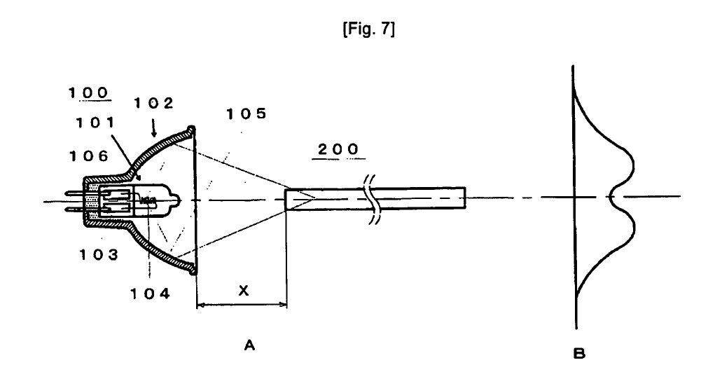

FIG. 5 is a schematic view of a third embodiment of the present invention, of which A shows a front view, and B a left side view. The right side view of the electric lamp in FIG. 5 is the same as said left side view. The electric lamp 50 of this embodiment is greatly different from the electric lamp of the first embodiment in FIG. 1 in that light is provided in two directions. A bulb 51 of the electric lamp 50 comprises a first curved face 52, having a substantially ellipsoidal shape in cross section with a first focal point F1 and a second focal point (not shown) and being convex outwardly. A reflective coating (diagonally shaded area in FIG. 5) is formed on the outer surface of the first curved face 52. The first focal point F1 of the first curved face 52 is positioned in the center of the coil part 16 of the filament 6. The second focal point of the first curved face 52 is positioned at an optical fiber (not shown) to which an emerged light generated at the coil part 16 of the filament 6 and reflected on the first curved face 52 is provided. Also, the bulb 51 comprises a second curved face 53, having a substantially ellipsoidal shape in cross section with the first focal point F1 and second focal point (not shown) and being convex outwardly. The first curved face 52 and the second curved face 53 have the same curvature. A reflective coating (diagonally shaded area in FIG. 5) is formed on the outer surface of the second curved face 53. The first focal point F1 of the second curved face 53 is also positioned in the center of the coil part 16 of the filament 6. The second focal point of the second curved face 53 is positioned at another optical fiber (not shown) to which an emerged light generated at the coil part 16 of the filament 6 and reflected on the second curved face 53 is provided. The material for these reflective coatings is the same as that described in FIG. 1.

According to this embodiment, the reflective coating formed on the outer surface of the first curved face 52 has a first opening 54. The first opening 54 has a circular shape and has a size of passing almost all of emerged light generated at the coil part 16 of the filament 6 at the first focal point F1 of the second curved face 53 and reflected on the second curved face 53. Also, the reflective coating formed on the outer surface of the second curved face 53 has a second opening 55. The second opening 55 also has a circular shape and has a size of passing almost all of emerged light generated at the coil part 16 of the filament 6 at the first focal point F1 of the first curved face 52 and reflected on the first curved face 52. In the area of the first opening 54, the first curved face 52 has a first flat portion and in the area of the second opening 55, the second curved face 53 has a second flat portion. These flat portions have the same works and effects as those described in the embodiment in FIG. 4.

Furthermore, the bulb 52 comprises a circumferential face 56 for interconnecting a circumferential end portion of the first curved face 52 and a circumferential end portion of the second curved face 53. As described above, providing the circumferential face 56 is advantageous for substantially fixing the thickness of the bulb 51 of the electric lamp 50 in the area of the inner space 57. Furthermore, providing the circumferential face 56 is advantageous in that when designing the bulb 51, by adapting, in dependence of the numerical aperture NA of the optical fiber used, not only the curvatures of the first curved face 52 and second curved face 53, but also the size in the width direction of the circumferential face 56 in association therewith, it is possible to make the area of the reflective surface of the bulb 51 as large as possible and make the first opening 54 and second opening 55 as small as possible. Note that no reflective coating is formed on the outer surface of the circumferential face 56. This is because the portion of the coil part 16 surrounded by the circumferential face 56 does not produce so a large light quantity. However, if desired, it is also possible to form a reflective coating, infrared cut filter or coating of other nature on the circumferential face 56.

In the optical fiber lighting system using the electric lamp 50 in this embodiment as a light source, two optical fibers are placed facing each other on both sides of the electric lamp 50 and the electric lamp 50 and these optical fibers are positioned as described in FIG. 3. In the electric lamp 50 of this embodiment, the reflective coating has the openings 54, 55, but a large quantity of parallel light from the square-shaped coil part 16 facing these openings directly enters the optical fiber, and therefore the light distribution characteristic of light emerged from the optical fiber is not doughnut-shaped but has a peak in the vicinity of the center. Therefore, this light distribution is also very suitable for the above-described applications of optical fiber lighting. Furthermore, compared to the embodiment with one-side coating in FIG. 1 and FIG. 4, the light condensing efficiency is increased. The above-described two optical fibers may be used for different lightings but may also be bundled into one for the same lighting.

FIG. 6 is a schematic view of a fourth embodiment of the present invention, of which A shows a front view, and B a left side view. In the electric lamp in FIG. 6, the right side view is the same as said left side view. The electric lamp 60 of this embodiment is different from the electric lamp 50 of the third embodiment in FIG. 5 in that in the bulb 61, the first opening in the third embodiment in FIG. 5 has a first protrusion 62 and the second opening therein has a second protrusion 63. In this embodiment, the end faces of these protrusions are flat. However, if desired, it is also possible to provide desired curvatures at the end faces of the protrusions 62, 63 and provide them with lens functions. It is also possible to form reflective coatings on the sides of the protrusions 62, 63 so as to prevent light from escaping from the sides of the protrusions. Note that the electric lamp 60 of this embodiment is advantageous in that it is possible to easily position the electric lamp and optical fiber by inserting these protrusions 62, 63 in the holes of the reference surfaces provided in the optical fiber lighting system.

In the embodiments explained with reference to FIG. 1 to FIG. 6, the curved face having a substantially ellipsoidal shape in cross section is made up of a portion having only one curvature. However, it is also possible to construct the curved face with portions having a plurality of curvatures and provide different second focal points in the optical fiber.

### INDUSTRIAL APPLICABILITY

The present invention can be used as a light source for an optical fiber lighting system used for irradiation of light necessary for lighting to illuminate areas near the hands of workers who perform elaborate work, for example, at a factory, decorative illumination of a show case or show window, and for irradiation necessary for an endoscope, scanner, photoenlarger, photopolymerizer, etc.

1. An electric lamp characterized by comprising: a bulb comprising a first curved face, the first curved face having a substantially ellipsoidal shape in cross section with a first focal point and a second focal point, and being convex outwardly, and;
a filament comprising a coil part formed by winding a wire and generating a light by being energized, the filament being so arranged that the coil part is positioned in an inner space of the bulb,
wherein a reflective coating is formed on the whole of outer surface or the whole of inner surface of the first curved face, and the first curved face is so adapted that the first focal point is positioned at the coil part, and the second focal point is positioned at a light transmission medium to which an emerged light generated at the coil part and reflected on the first curved face is provided.

2. An electric lamp as claimed in claim 1 characterized in that a second face, facing the first curved face, includes a substantially spherical shape.

3. An electric lamp as claimed in claim 1 characterized in that the bulb comprises a circumferential face for interconnecting a circumferential end portion of the first curved face and a circumferential end portion of the second face.

4. An electric lamp as claimed in claim 1, characterized in that the second face includes a flat portion.

5. An electric lamp as claimed in claim 4 characterized in that the flat portion has a circular shape, and has at least a size of passing almost all of emerged light generated at the coil part at the first focal point and reflected on the first curved face.

6. An electric lamp as claimed in claim 1, characterized in that the second face comprises a protrusion portion which protrudes toward the light transmission medium.

7. An electric lamp as claimed in claim 1, characterized in that the second face has a coating for reflecting, transmitting or absorbing a light of a particular wavelength.

8. An electric lamp characterized by comprising:
a bulb comprising a first curved face, the first curved face having a substantially ellipsoidal shape in cross section with a first focal point and a second focal point, and being convex outwardly, and a second curved face, facing the first curved face, the second curved face having a substantially ellipsoidal shape in cross section with a first focal point and a second focal point, and being convex outwardly, and;
a filament comprising a coil part formed by winding a wire and generating a light by being energized, the filament being so arranged that the coil part is positioned in an inner space of the bulb,
wherein the respective reflective coatings are formed on the first curved face and the second curved face,
the reflective coating comprises an opening for passing an emerged light generated at the coil part and reflected on the first curved face or the second curved face,
the first curved face is so adapted that the first focal point is positioned at the coil part, and the second focal point is positioned at a light transmission medium to which an emerged light generated at the coil part and reflected on the first curved face is provided through the opening, and
the second curved face is so adapted that the first focal point is positioned at the coil part, and the second focal point is positioned at a light transmission medium to which an emerged light generated at the coil part and reflected on the second curved face is provided through the opening.

9. An electric lamp as claimed in claim 8 characterized in that the first curved face and the second curved face have the same curvature.

10. An electric lamp as claimed in claim 8 characterized in that at least one of the openings has a circular shape, and has at least a size of passing almost all of emerged light generated at the coil part at the first focal point of the first curved face or the second curved face and reflected on the first curved face or the second curved face.

11. An electric lamp as claimed in claim 8, characterized in that at least one of the openings includes a flat portion.

12. An electric lamp as claimed in claim 8, characterized in that at least one of the openings comprise a protrusion portion which protrudes toward the light transmission medium.

13. An electric lamp as claimed in claim 6 characterized in that an end face of the protrusion portion has a lens effect.

14. An electric lamp as claimed in claim 6, characterized in that a reflective coating is formed on a side face of the protrusion portion.

15. An electric lamp as claimed in claim 1 characterized in that the coil part has a square shape or a circular shape as viewed from the light transmission medium side.

16. An electric lamp as claimed in claim 1 characterized in that the bulb comprises a circumferential face for interconnecting a circumferential end portion of the first curved face and a circumferential end portion of the second curved face.

17. An electric lamp as claimed in claim 1 characterized in that the material of the reflective coating is Ta₂O₅/SiO₂.

18. An electric lamp as claimed in claim 1 characterized in that the first curved face and/or the second curved face consist of plural portions with different curvatures.

19. An electric lamp as claimed in claim 1 characterized in that halogen is filled in the inner space of the bulb.

20. A light transmission medium lighting system characterized by comprising an electric lamp and a light transmission medium,
the electric lamp comprising:
a bulb comprising a first curved face, the first curved face having a substantially ellipsoidal shape in cross section with a first focal point and a second focal point, and being convex outwardly, and a second face, facing the first curved face;
a filament comprising a coil part formed by winding a wire and generating a light by being energized, the filament being so arranged that the coil part is positioned in an inner space of the bulb; and
the light transmission medium being arranged in the vicinity of the second face, to which an emerged light generated at the coil part and reflected on the first curved face is provided,
wherein a reflective coating is formed on the whole of outer surface or the whole of inner surface of the first curved face, and the first curved face is so adapted that the first focal point is positioned at the coil part, and the second focal point is positioned at the light transmission medium.

21. A light transmission medium lighting system characterized by comprising an electric lamp and two light transmission media,
the electric lamp comprising:
a bulb comprising a first curved face, the first curved face having a substantially ellipsoidal shape in cross section with a first focal point and a second focal point, and being convex outwardly, and a second curved face, facing the first curved face, the second curved face having a substantially ellipsoidal shape in cross section with a first focal point and a second focal point, and being convex outwardly, and;
a filament comprising a coil part formed by winding a wire and generating a light by being energized, the filament being so arranged that the coil part is positioned in an inner space of the bulb; and
the two light transmission media being arranged in the vicinity of the first curved face and the second curved face, respectively, to which an emerged light generated at the coil part and reflected on the first curved face or the second curved face is provided,
wherein the respective reflective coatings are formed on the first curved face and the second curved face,
the reflective coating comprises an opening for passing an emerged light generated at the coil part and reflected on the first curved face or the second curved face,
the first curved face is so adapted that the first focal point is positioned at the coil part, and the second focal point is positioned at one light transmission medium to which an emerged light reflected on the first curved face is provided through the opening, and
the second curved face is so adapted that the first focal point is positioned at the coil part, and the second focal point is positioned at the other light transmission medium to which an emerged light reflected on the second curved face is provided through the opening.
